(19) United States
(12) Patent Application Publication
(10) Pub. No.: US 2013/0069966 A1
(43) Pub. Date: Mar. 21, 2013

(54) Frame Buffer Pixel Circuit of Liquid Crystal on Silicon Display Device

(71) Applicants: Bohua Zhao, Beijing (CN); Ran Huang, Beijing (CN); Huan Du, Beijing (CN); Jiajun Luo, Beijing (CN); Bin Lin, Hangzhou (CN)

(72) Inventors: Bohua Zhao, Beijing (CN); Ran Huang, Beijing (CN); Huan Du, Beijing (CN); Jiajun Luo, Beijing (CN); Bin Lin, Hangzhou (CN)

(21) Appl. No.: 13/701,009

(22) PCT Filed: Aug. 17, 2011
(86) PCT No.: PCT/CN11/01366

§ 371 Date: Nov. 29, 2012

(30) Foreign Application Priority Data
Aug. 25, 2010 (CN) 201010263098.1

(51) Int. Cl. G09G 5/00

(52) U.S. Cl. CPC G09G 5/001
USPC 345/545

(57) ABSTRACT

The present invention discloses a frame buffer pixel circuit for a LCoS display device, wherein said circuit consists of a first transistor (M1), a second transistor (M2), a third transistor (M3), a fourth transistor (M4), a fifth transistor (M5), a sixth transistor (M6), a storage capacitor (C1) and a pixel capacitor (C2), wherein, the first transistor (M1) forms a pre-charge circuit, the second transistor (M2) and the third transistor (M3) form a threshold voltage generating circuit, the storage capacitor (C1) forms a sample and hold circuit, the fourth transistor (M4), the fifth transistor (M5) and the pixel capacitor (C2) form an input data voltage read-in circuit, and the sixth transistor (M6) forms a discharge circuit. The present invention has a threshold voltage added when writing the input data voltage into the storage capacitor so as to cancel out the threshold voltage lost by reading the voltage on the storage capacitor onto the pixel capacitor, thereby ensuring consistency of the output pixel voltage and improving the display effect.

### TECHNICAL FIELD

The present invention relates to a Liquid Crystal on Silicon (LCoS) micro-display device, in particular to a frame buffer pixel circuit of a LCoS display device.

### BACKGROUND OF THE INVENTION

LCoS is a new display technique that combines the CMOS integrated circuit technique with the liquid crystal display technique. Compared with transmissive LCD and DLP, LCoS has such characteristics as high light utilization efficiency, compact system size, high aperture ratio and low manufacturing cost. The most significant advantage of LCoS is that the resolution thereof can be made to be very high, and this advantage is incomparable by other techniques when it comes to the application to portable projection devices.

At present, the mainly used methods to realize LCoS color display is time sequential color method and color filters method, wherein, the color filters method influences the aperture ratio and has higher requirements on alignment of the color filtering film and on the sticking process, so the time sequential color method is mainly used in the design of the LCoS pixel circuit. The time sequential color method shortens the illumination time of the light source, so the mainstream solution is using a frame buffer pixel circuit, which is characterized by storing display data of the next frame on the capacitor first, and then reading the stored data into the pixel capacitor at one time through a reading signal so as to be display. The basic principle thereof is hiding the time of reading the next frame of data into the liquid crystal response time and illumination time of the previous frame, thereby prolonging the illumination time and increasing the contrast of display. In the conventional scheme (FIG. 1), data voltages are transferred from the gate to the source of a MOS transistor, and the voltages obtained by the source have threshold losses, and because the data voltages are different, the threshold voltages loss are also different, so there is a non-linear relationship between the output pixel voltage and the input data voltage, which influences the consistency of the pixel output voltage, and accordingly influences the final display effect.

### SUMMARY OF THE INVENTION

(I) Technical Problem To Be Solved

With respect to the defect that in the conventional pixel circuit scheme, the data voltage has a threshold voltage loss after being transferred from the gate to the source of a MOS transistor, which influences consistency of the pixel output voltage, the present invention mainly aims at providing a frame buffer pixel circuit to reduce the threshold loss and improve stability and consistency of the pixel output voltage, thereby improving the display effect.

(II) Technical Solution

To this end, the present invention provides a frame buffer pixel circuit of a LCoS display device, which consists of a first transistor M1, a second transistor M2, a third transistor M3, a fourth transistor M4, a fifth transistor M5, a sixth transistor M6, a storage capacitor C1 and a pixel capacitor C2, wherein, the first transistor M1 forms a pre-charge circuit, the second transistor M2 and the third transistor M3 form a threshold voltage generating circuit, the storage capacitor C1 forms a sample and hold circuit, the fourth transistor M4, the fifth transistor M5 and the pixel capacitor C2 form an input data voltage read-in circuit, and the sixth transistor M6 forms a discharge circuit.

Wherein, a drain of the first transistor M1 is connected to a gate and drain of the second transistor M2, and is connected, in the meantime, to one end of the storage capacitor C1 and a gate of the fourth transistor M4; a source of the first transistor M1 is connected to an external supply voltage, a gate of the first transistor M1 is connected to an external charging control signal and pre-charges one end of the storage capacitor C1 to the supply voltage through the first transistor M1; the other end of the storage capacitor C1 is grounded.

Wherein, a source of the second transistor M2 is connected to a drain of the third transistor M3.

Wherein, a source of the third transistor M3 is connected to an input data voltage, a gate thereof is connected to an external writing signal to control writing of data.

Wherein, a drain of the fourth transistor M4 is connected to the supply voltage and a source thereof is connected to a drain of the fifth transistor M5.

Wherein, a gate of the fifth transistor M5 is connected to an external read-in control signal, a source thereof is connected to one end of the pixel capacitor C2 and a drain of the sixth transistor M6; the other end of the pixel capacitor C2 is grounded.

Wherein, a source of the sixth transistor M6 is grounded, a gate thereof is connected to an external discharging control signal, so that the voltage across the pixel capacitor C2 discharges through the sixth transistor M6.

Wherein, the first transistor M1 is a PMOS transistor, the second transistor M2, the third transistor M3, the fourth transistor M4, the fifth transistor M5, the sixth transistor M6 all are NMOS transistors.

Wherein, the storage capacitor C1 is charged to the supply voltage in the pre-charging stage; an input data voltage V_{data} is written when the third transistor M3 is switched ON, and the storage capacitor C1 discharges to V_{data}+V_{TH2} at this time, V_{TH2} being a threshold voltage of the second transistor; in the data read-in stage, the fifth transistor M5 is switched on, and the voltage of the storage capacitor C1 is V_{data}+V_{TH2} at this time, and the pixel capacitor C2 is charged to V_{data}.

(III) Advantageous Effect

It can be seen from the above technical solution that the present invention has the following advantageous effects:

1. In the frame buffer pixel circuit of the LCoS display device provided by the present invention, data writing-in is realized through discharging the storage capacitor that has been pre-charged to the supply voltage. When discharging the storage capacitor to a sum of the input data voltage and the threshold voltage (which changes with the input data voltage) through the second transistor, the second transistor is switched off, so the value stored on the storage capacitor during the data writing-in phase is a sum of the input data voltage and the threshold voltage. When transferring the voltage on the storage capacitor to the pixel capacitor through the fourth transistor, since threshold loss occurs when transferring voltage through the gate of the fourth transistor, the voltage finally transferred to the pixel capacitor is a difference between the voltage on the storage capacitor and the threshold voltage, i.e. the input data voltage.

2. In the conventional pixel circuit scheme, threshold voltage loss occurs when transferring voltage through a transistor, which results in inconsistency of the finally output voltage. But the present invention has a threshold voltage added when storing the input data voltage so as to cancel out the threshold loss during transfer of the voltage, thereby improving stability and consistency of the output voltage and improving the display effect.

### BRIEF DESCRIPTION OF THE DRAWINGS

FIG. 1 is a structural diagram of the frame buffer pixel circuit in the conventional pixel circuit scheme;

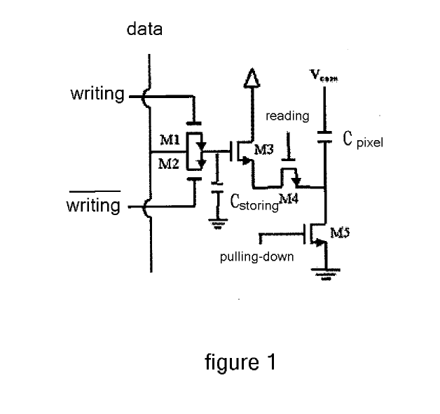

FIG. 2 is a structural diagram of the frame buffer pixel circuit for a LCoS display device provided by the present invention;

FIG. 3 is a signal time sequence diagram of the frame buffer pixel circuit for a LCoS display device provided by the present invention.

### DETAILED DESCRIPTION OF THE INVENTION

To make the object, technical solution and advantages of the present invention clearer, the present invention is further described in detail below in conjunction with specific embodiments and with reference to the drawings.

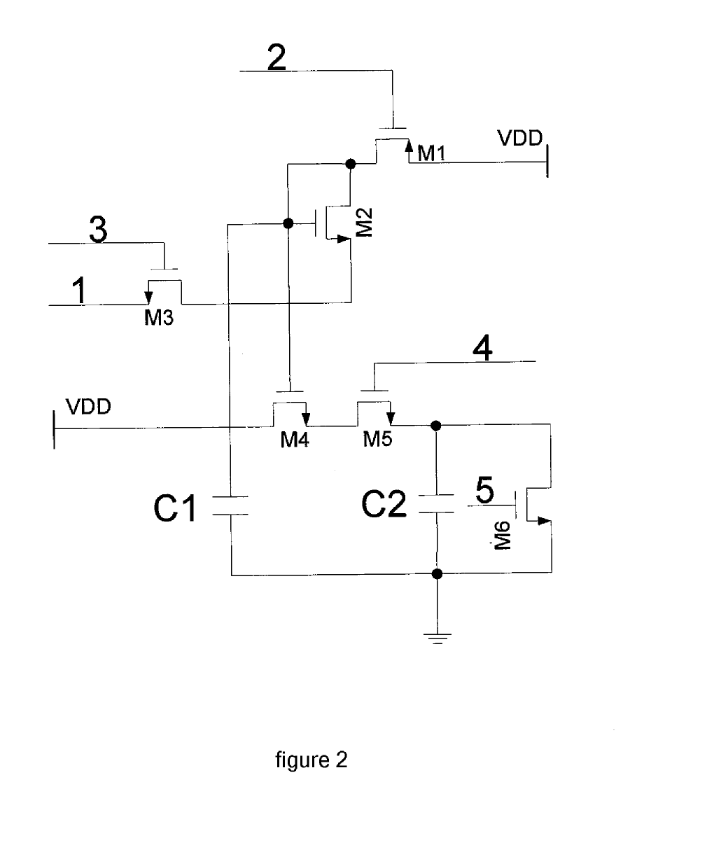

FIG. 2 is a structural diagram of the frame buffer pixel circuit for a LCoS display device provided by the present invention. The circuit consists of a first transistor M1, a second transistor M2, a third transistor M3, a fourth transistor M4, a fifth transistor M5, a sixth transistor M6, a storage capacitor C1 and a pixel capacitor C2. The first transistor M1 forms a pre-charging circuit. The second transistor M2 and the third transistor M3 form a threshold voltage generating circuit. The storage capacitor C1 forms a sample and hold circuit. The fourth transistor M4, the fifth transistor M5 and the pixel capacitor C2 form an input data voltage read-in circuit. The sixth transistor M6 forms a discharging circuit.

The drain of the first transistor M1 is connected to the gate and drain of the second transistor M2, and is connected, in the meantime, to one end of the storage capacitor C1 and the gate of the fourth transistor M4. The source of the first transistor M1 is connected to an external supply voltage. The gate of the first transistor M1 is connected to an external charging control signal. One end of the storage capacitor C1 is pre-charged to a supply voltage through the first transistor M1. The other end of the storage capacitor C1 is grounded. The source of the second transistor M2 is connected to the drain of the third transistor M3. The source of the third transistor M3 is connected to an input data voltage and the gate thereof is connected to an external writing signal to control writing of data. The drain of the fourth transistor M4 is connected to the supply voltage and the source thereof is connected to the drain of the fifth transistor M5. The gate of the fifth transistor M5 is connected to an external read-in control signal, and the source thereof is connected to one end of the pixel capacitor C2 and the drain of the sixth transistor M6. The other end of the pixel capacitor C2 is grounded. The source of the sixth transistor M6 is grounded, and the gate thereof is connected to an external discharging control signal, so that the voltage across the pixel capacitor C2 is discharged through the sixth transistor M6. The first transistor M1 uses a PMOS transistor. The second transistor M2, the third transistor M3, the fourth transistor M4, the fifth transistor M5, the sixth transistor M6 all use NMOS transistors. The storage capacitor C1 and pixel capacitor C2 are dependent on a pixel voltage error tolerance.

Wherein, the storage capacitor C1 is charged to the supply voltage in a pre-charge stage; an input data voltage V_{data} is written when the third transistor M3 is switched ON, and the storage capacitor C1 is discharged to V_{data}+V_{TH2} at this time, V_{TH2} being a threshold voltage of the second transistor; in the data read-in stage, the fifth transistor M5 is switched on, and the voltage of the storage capacitor C1 is V_{data}+V/_{TH2} at this time, and the pixel capacitor C2 is charged to V_{data}.

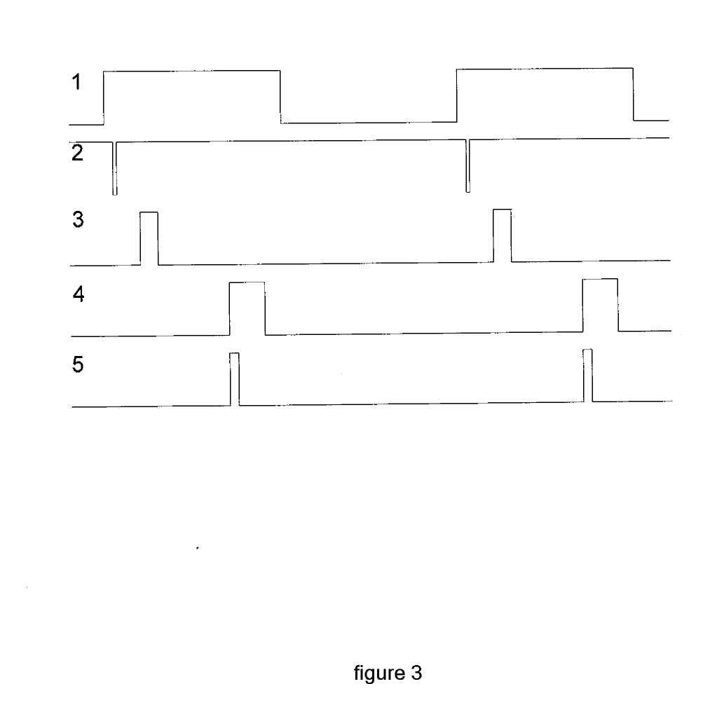

FIG. 3 is a signal time sequence diagram of the frame buffer pixel circuit for a LCoS display device provided by the present invention. A data signal 1, a pre-charging signal 2, a writing signal 3, a reading signal 4 and a discharging signal 5 are shown in FIGS. 2 and 3. The data signal 1 is connected to the source of the third transistor M3. The pre-charging signal 2 is connected to the gate of the first transistor M1. The writing signal 3 is connected to the gate of the third transistor M3. The reading signal 4 is connected to the gate of the fifth transistor M5. The discharging signal 5 is connected to the gate of the sixth transistor M6. The gate reading signal 4 of the fifth transistor M5 includes the gate discharging signal 5 of the sixth transistor M6 in time sequence.

In the frame buffer pixel circuit provided by the present invention, a frame of time is divided into three parts: data writing-in time, liquid crystal material response time and light source illumination time. The data writing-in time and the light source illumination time partially overlap. In the data writing-in stage, the pre-charging signal 2 first changes to a low level, the supply voltage charges the storage capacitor C1 to the supply voltage through the first transistor M1; then the writing signal 3 changes to a high level, and the data signal 1 is transferred to the drain of the second transistor M2 and the storage capacitor C1 through the third transistor M3. When the voltage across the storage capacitor C1 is discharged to a sum of a data signal voltage and a threshold voltage of the second transistor M2 through the second transistor M2 and the third transistor M3, the second transistor M2 is switched off. And the voltage stored on the storage capacitor C1 at this time is a sum of the data signal voltage and the threshold voltage of the second transistor M2. After writing data voltage of each row to each pixel storage capacitor C1, the reading signal 4 changes to a high level, the fifth transistor M5 is switched on, the discharging signal 5 also changes to a high level, and the sixth transistor M6 is also switched on. The voltage across the pixel capacitor C2 first is discharged to a low level through the sixth transistor M6, then the discharging signal 5 changes to a low level. The reading signal 4 is still a high level. The voltage stored on the storage capacitor C1 charges the pixel capacitor C2 through the fourth transistor M4 and the fifth transistor M5. When the pixel capacitor C2 is charged to the data signal voltage, since the gate voltage of the fourth transistor M4 is a sum of the data signal voltage and the threshold voltage of the transistor M2, the fourth transistor M4 is switched off. The voltage stored on the pixel capacitor C2 is the data signal voltage, and the pixel capacitor enters a pixel voltage holding stage.

The above described specific embodiment further illustrates the object, technical solution and advantageous effect of the present invention. But it shall be understood that the above described in only a specific embodiment of the present invention, it is not intended to limit the present invention. Any modification, equivalent substitution and improvement made within the spirit and principle of the present invention shall be included in the protection scope of the present invention.

What is claimed is:

1. A frame buffer pixel circuit of a LCoS display device, wherein said circuit comprises: a first transistor (M1), a second transistor (M2), a third transistor (M3), a fourth transistor (M4), a fifth transistor (M5), a sixth transistor (M6), a storage capacitor (C1) and a pixel capacitor (C2), wherein, the first transistor (M1) forms a pre-charge circuit, the second transistor (M2) and the third transistor (M3) form a threshold voltage generating circuit, the storage capacitor (C1) forms a sample and hold circuit, the fourth transistor (M4), the fifth transistor (M5) and the pixel capacitor (C2) form an input data voltage read-in circuit, and the sixth transistor (M6) forms a discharge circuit.

2. The frame buffer pixel circuit for a LCoS display device according to claim 1, wherein a drain of the first transistor (M1) is connected to a gate and a drain of the second transistor (M2), and is connected, in the meantime, to one end of the storage capacitor (C1) and a gate of the fourth transistor (M4); a source of the first transistor (M1) is connected to an external supply voltage, a gate of the first transistor (M1) is connected to an external charging control signal and pre-charges one end of the storage capacitor (C1) to the supply voltage through the first transistor (M1); another end of the storage capacitor (C1) is grounded.

3. The frame buffer pixel circuit for a LCoS display device according to claim 2, wherein a source of the second transistor (M2) is connected to a drain of the third transistor (M3).

4. The frame buffer pixel circuit for a LCoS display device according to claim 3, wherein a source of the third transistor (M3) is connected to an input data voltage, a gate thereof is connected to an external writing signal to control writing of data.

5. The frame buffer pixel circuit for a LCoS display device according to claim 4, wherein a drain of the fourth transistor (M4) is connected to the supply voltage and a source thereof is connected to a drain of the fifth transistor (M5).

6. The frame buffer pixel circuit for a LCoS display device according to claim 5, wherein a gate of the fifth transistor (M5) is connected to an external read-in control signal, a source thereof is connected to one end of the pixel capacitor (C2) and a drain of the sixth transistor (M6); another end of the pixel capacitor (C2) is grounded.

7. The frame buffer pixel circuit for a LCoS display device according to claim 6, wherein a source of the sixth transistor (M6) is grounded, a gate thereof is connected to an external discharging control signal, so that the voltage across the pixel capacitor (C2) discharges through the sixth transistor (M6).

8. The frame buffer pixel circuit for a LCoS display device according to claim 1, wherein the first transistor (M1) is a PMOS transistor, the second transistor (M2), the third transistor (M3), the fourth transistor (M4), the fifth transistor (M5), the sixth transistor (M6) all are NMOS transistors.

9. The frame buffer pixel circuit for a LCoS display device according to claim 1, wherein the storage capacitor (C1) is charged to the supply voltage in the pre-charging stage; an input data voltage V_{data} is written when the third transistor (M3) is switched ON, and the storage capacitor (C1) discharges to V_{data}+V_{TH2} at this time, V_{TH2} being a threshold voltage of the second transistor; in the data read-in stage, the fifth transistor (M5) is switched on, and the voltage of the storage capacitor (C1) is V_{data}+V_{TH2} at this time, and the pixel capacitor (C2) is charged to V_{data}.
